(19) United States
(12) Patent Application Publication
(10) Pub. No.: US 2024/0222631 A1
(43) Pub. Date: Jul. 4, 2024

(54) CATHODE, LITHIUM SECONDARY BATTERY INCLUDING THE SAME, AND METHOD OF PREPARING CATHODE

(71) Applicant: Samsung Electronics Co., Ltd., Suwon-si (KR)

(72) Inventors: Sungjin Lim, Suwon-si (KR); Hwiyeol Park, Suwon-si (KR); Jonghoon Ka, Suwon-si (KR); Taeyoung Kim, Suwon-si (KR); Heungchan Lee, Suwon-si (KR)

(21) Appl. No.: 18/400,003

(22) Filed: Dec. 29, 2023

(30) Foreign Application Priority Data
Dec. 29, 2022 (KR) 10-2022-0189816

(51) Int. Cl. H01M 4/62; H01M 4/131; H01M 4/1391; H01M 4/36; H01M 4/525; H01M 10/052; H01M 10/0562

(52) U.S. Cl. CPC H01M 4/62; H01M 4/131; H01M 4/1391; H01M 4/366; H01M 4/525; H01M 10/052; H01M 10/0562; H01M 2004/028

(57) ABSTRACT

A cathode including a cathode active material layer including a composite cathode active material particle including a core, and a coating layer disposed on at least a portion of the core, wherein the core includes a lithium transition metal oxide, and the coating layer includes a first solid electrolyte, wherein the first solid electrolyte is a halogen-containing oxide solid electrolyte, and a matrix comprising a second solid electrolyte, wherein the second solid electrolyte is a halogen-free oxide solid electrolyte, and wherein the composite cathode active material particle is disposed in the second solid electrolyte, and wherein the first solid electrolyte and the second solid electrolyte each comprise silicon and boron.

### CROSS-REFERENCE TO RELATED APPLICATION

This application is based on and claims priority to Korean Patent Application No. 10-2022-0189816, filed on Dec. 29, 2022, in the Korean Intellectual Property Office, and all the benefits accruing therefrom under 35 U.S.C. § 119, the content of which is incorporated by reference herein in its entirety.

### BACKGROUND

### 1. Field

The disclosure relates to a cathode, a lithium secondary battery including the same, and a method of preparing a cathode.

### 2. Description of the Related Art

In recent years, batteries providing increased energy density and safety have been actively developed. Lithium batteries are used in information devices, communication devices, or automobiles. In particular, automobile safety is greatly emphasized as it directly affects human lives.

A lithium battery including a liquid electrolyte includes a flammable organic solvent. A lithium battery including a liquid electrolyte has a high risk for overheating and fire hazards in the event of a short-circuit.

A battery using a solid electrolyte has a lower risk for fire or explosion in the event of a short-circuit. Such lithium batteries using a solid electrolyte may provide increased safety compared to lithium batteries including a liquid electrolyte.

### SUMMARY

To increase the voltage and capacity of a battery, there is a need for a cathode, which is applicable for low-temperature co-sintering at a temperature of about 500° C. or less for the application with LiCoO₂ and graphite, and includes an all-solid electrolyte that is a mixed ion-electron conductor with excellent electron conductivity and ion conductivity. For example, an amorphous electrolyte used in a cathode has high capacity and high voltage and is suitable for co-sintering, but has low ion conductivity and electron conductivity. In this context, there is a need for a solid electrolyte for use in a cathode, which has excellent ion conductivity and electron conductivity and at the same time, can be co-sintered at a low temperature.

Provided is a novel cathode.

Provided is a lithium secondary battery including the cathode.

Provided is a method of preparing the cathode.

Additional aspects will be set forth in part in the description which follows and, in part, will be apparent from the description, or may be learned by practice of the presented embodiments of the disclosure.

According to an aspect of the disclosure, a cathode includes:
a cathode active material layer including
a composite cathode active material particle including
a core, and
a coating layer disposed on at least a portion of the core,
wherein the core includes a lithium transition metal oxide, and the coating layer includes a first solid electrolyte, wherein the first solid electrolyte is a halogen-containing oxide solid electrolyte; and
a matrix including a second solid electrolyte, wherein the second solid electrolyte is a halogen-free oxide solid electrolyte, and wherein the composite cathode active material particle is disposed in the second solid electrolyte, and
wherein the first solid electrolyte and the second solid electrolyte each include silicon and boron.

According to another aspect of the disclosure, a cathode may include a cathode active material layer,
wherein the cathode active material layer includes a second solid electrolyte having a matrix form; and composite cathode active material particles disposed in the second solid electrolyte,
wherein the composite cathode active material particles each include a core and a coating layer disposed on at least a portion of the core,
wherein the core includes a lithium transition metal oxide, and the coating layer includes a first solid electrolyte,
wherein the first solid electrolyte is a halogen-containing oxide-based solid electrolyte, and the second solid electrolyte is a halogen-free oxide-based solid electrolyte.

According to another embodiment of the disclosure, a lithium battery includes the cathode;
an anode; and an electrolyte between the cathode and the anode.

According to another embodiment of the disclosure, a method of preparing a cathode includes:
providing a composite cathode active material particle including
a core, and a coating layer disposed on at least a portion of the core,
wherein the core includes a lithium transition metal oxide, and the coating layer includes a first solid electrolyte, wherein the first solid electrolyte is a halogen-containing oxide solid electrolyte;
impregnating the composite cathode active material particle into a matrix including a second solid electrolyte, wherein the second solid electrolyte is a halogen-free oxide solid electrolyte to form an impregnated matrix; and
heat-treating the impregnated matrix to form a cathode active material layer to form the cathode,
wherein the first solid electrolyte and the second solid electrolyte each include silicon and boron.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional view of an embodiment of a lithium secondary battery;

FIG. 2 is an enlarged cross-sectional view of Area A depicted in FIG. 1;

FIG. 3 is a graph of ion conductivity (σ_{Ion}, Siemens per centimeter, S/cm) vs. temperature (° C.) showing ion conductivity according to a sintering temperature of a solid electrolyte;

FIG. 4 is a graph of electron conductivity (σ_{Electron}, S/cm) vs. temperature (C) showing electron conductivity according to a sintering temperature of a solid electrolyte;

FIG. 5 is a graph of (ion conductivity/electron conductivity) (σ_{Ion}/σ_{Electron}) vs. temperature (° C.) showing ion conductivity with respect to electron conductivity according to a sintering temperature of a solid electrolyte;

FIGS. 6 to 8 are each a cross-sectional view of an embodiment of a multilayer ceramic (MLC) cell;

FIGS. 9A and 9B are each a graph of voltage (Volts (V) vs. Li/Li⁺) vs. specific capacity (milliampere hours per gram, mAh/g) of an embodiment illustrating the results of measurement of charging/discharging characteristics of an example; and

FIGS. 10A to 10E are each a graph of voltage (V vs. Li/Li⁺) vs. specific capacity (mAh/g) of an embodiment showing the results of measurement of charging/discharging characteristics of a comparative example.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain various aspects. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

The present inventive concept, which will be more fully described hereinafter, may have various variations and various embodiments, and specific embodiments will be illustrated in the accompanied drawings and described in greater details. However, the present inventive concept should not be construed as being limited to specific embodiments set forth herein. Rather, these embodiments are to be understood as encompassing all variations, equivalents, or alternatives included in the scope of the present inventive concept.

The terminology used hereinbelow is used for the purpose of describing particular embodiments only and is not intended to limit the present inventive concept. As used herein, the singular forms are intended to include the plural forms as well, unless the context clearly indicates otherwise. As used herein, the terms “comprises” and/or “comprising,” or “includes” and/or “including” when used in this specification, specify the presence of stated features, regions, integers, steps, operations, elements, components, ingredients, materials, or combinations thereof, but do not preclude the presence or addition of one or more other features, regions, integers, steps, operations, elements, components, ingredients, materials, or combinations thereof. As used herein, “/” may be interpreted as “and”, or as “or” depending on the context.

In the drawings, the thicknesses of layers and regions may be exaggerated for clarity of description. Like reference numerals denote like elements throughout the specification. Throughout the specification, when a component, such as a layer, a film, a region, or a plate, is described as being “above” or “on” another component, the component may be directly above the another component, or there may be yet another component therebetween. It will be understood that although the terms “first,” “second,” etc. may be used herein to describe various elements, these elements should not be limited by these terms. These terms are only used to distinguish one element from another element. In an aspect, these terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value. Endpoints of ranges may each be independently selected.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, the term “metal” refers to both metals and metalloids such as silicon and germanium, in an elemental or ionic state.

As used herein, the term “alloy” means a mixture of two or more metals.

As used herein, the term “cathode active material” refers to a cathode material capable of undergoing lithiation and delithiation.

As used herein, the term “anode active material” refers to an anode material capable of undergoing lithiation and delithiation.

As used herein, the terms “lithiation” and “to lithiate” refer to a process of adding lithium to a cathode active material or an anode active material.

As used herein, the terms “delithiation” and “to delithiate” refer to a process of removing lithium from a cathode active material or an anode active material.

As used herein, the terms “charging” and “charge” refer to a process of providing electrochemical energy to a battery.

As used herein, the terms “discharging” and “discharge” refer to a process of removing electrochemical energy from a battery.

As used herein, the terms “positive electrode” and “cathode” refer to an electrode at which electrochemical reduction and lithiation take place during the discharging process.

As used herein, the terms “negative electrode” and “anode” refer to an electrode at which electrochemical oxidation and delithiation take place during the discharging process.

In the present application, the term “particle diameter” of a particle refers to an average particle diameter if the particle is spherical, and for a particle that is non-spherical, said term refers to an average major axis length of the particle. The particle diameter of particles may be measured using a particle size analyzer (PSA). “Particle diameter” of particles may be, for example, an average diameter of the particles. The average particle diameter refers to a median particle diameter (D50) unless explicitly stated otherwise. The median particle diameter (D50) refers to a particle size corresponding to a cumulative volume of 50 volume percent (vol %) counted from the smallest particle size on a particle size distribution curve in which particles are accumulated from the smallest particle size to the largest particle size. The cumulative value may be, for example, cumulative volume. The median particle diameter may be measured by, for example, a laser diffraction method.

Hereinafter, a cathode, a secondary battery, and a method for preparing a cathode according to example embodiments will be described in greater detail.

In an aspect, a cathode comprises:
a cathode active material layer comprising
   a composite cathode active material particle comprising
      a core, and
      a coating layer disposed on at least a portion of the core,
      wherein the core comprises a lithium transition metal oxide, and the coating layer comprises a first solid electrolyte, wherein the first solid electrolyte is a halogen-containing oxide solid electrolyte; and
   a matrix comprising a second solid electrolyte, wherein the second solid electrolyte is a halogen-free oxide solid electrolyte, and
   wherein the composite cathode active material particle is disposed in the second solid electrolyte, and
   wherein the first solid electrolyte and the second solid electrolyte each comprise silicon and boron.

In an aspect, the second solid electrolyte may be in a form of a matrix, thus the second solid electrolyte having a matrix form.

In an aspect, a halogen content of the halogen-free oxide solid electrolyte may be 0 mole percent to about 1 mole percent, about 0.0001 mole percent to about 1 mole percent, about 0.0001 mole percent to about 0.75 mole percent, about 0.001 mole percent to about 0.5 mole percent, or about 0.01 mole percent to about 0.1 mole percent, based on a total content of the halogen-free oxide solid electrolyte.

The cathode according to an embodiment may include a cathode current collector and the cathode active material layer disposed on one side of the cathode current collector, wherein the cathode active material layer may include the second solid electrolyte having the matrix form; and composite cathode active material particles disposed in the second solid electrolyte.

The composite cathode active material particles may each include the core and the coating layer disposed on at least the portion of the core, wherein the core may include the lithium transition metal oxide, the coating layer may include the first solid electrolyte, the first solid electrolyte may be the halogen-containing oxide-based (i.e., oxide) solid electrolyte, and the second solid electrolyte may be the halogen-free oxide-based solid electrolyte. The first solid electrolyte as the halogen-containing oxide-based solid electrolyte due to having excellent electron conductivity may increase an initial capacity and rate capability of a secondary battery including the cathode. The rate capability is described as the capacity at various rates versus the capacity on 0.05 C discharge.

The first solid electrolyte and the second solid electrolyte included in the cathode according to an embodiment may each include silicon (Si) and boron (B). When the first solid electrolyte and the second solid electrolyte each include silicon (Si) and boron (B), the cathode active material, the first solid electrolyte, and the second solid electrolyte may be co-sintered at a low temperature. This may allow the cathode to be manufactured more quickly and prevent performance degradation due to exposure of cathode active material to a high temperature during the manufacturing process.

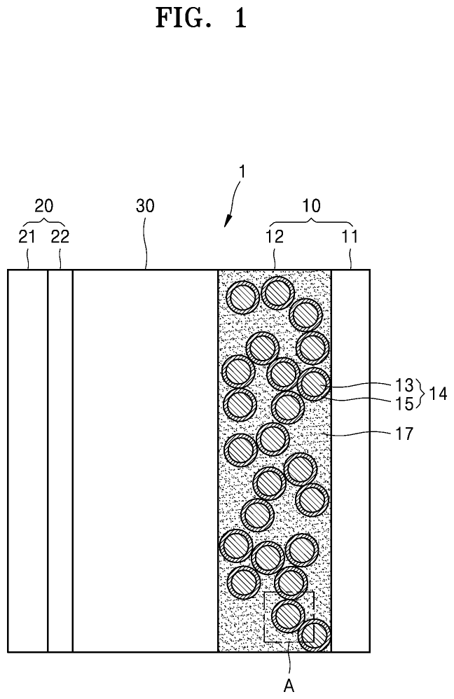

FIG. 1 is a cross-sectional view of an all-solid secondary battery according to an embodiment.

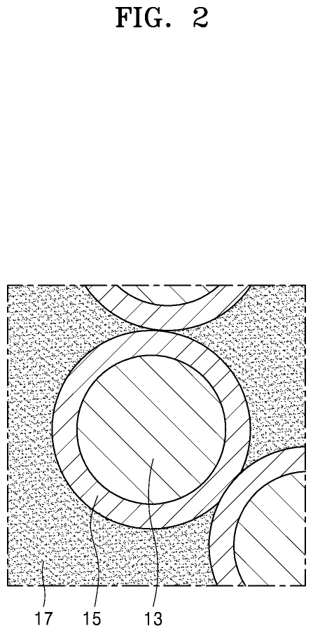

FIG. 2 is an enlarged view of a cathode layer according to an embodiment.

Referring to FIG. 1, a lithium secondary battery 1 may include: an anode layer 20 including an anode active material layer 22; a cathode layer 10 including a cathode active material layer 12; and an electrolyte layer 30 between the anode layer 20 and the cathode layer 10.

According to an embodiment, the electrolyte layer 30 may be a solid electrolyte layer.

In this specification, the anode layer 20 may be referred to as an anode 20, and the cathode layer 10 may also be referred to as a cathode 10 for convenience of description, while the anode layer 20 and the anode 20 refer to the same element, and the cathode layer 10 and the cathode 10 refer to the same element.

### Cathode Layer

### Cathode Layer: Cathode Active Material Layer

FIGS. 1 and 2, the cathode layer 10 may include a cathode active material layer 12, wherein the cathode active material layer 12 may include a second solid electrolyte 17 having a matrix form and composite cathode active material particles 14 disposed in the second solid electrolyte 17, wherein the composite cathode active material particles 14 may each include a core 13 and a coating layer 15 disposed on at least a portion of the core 13, wherein the core 13 may include a lithium transition metal oxide, and the coating layer 15 may include a first solid electrolyte, wherein the first solid electrolyte may be a halogen-containing oxide-based solid electrolyte, and the second solid electrolyte may be a halogen-free oxide-based solid electrolyte.

For example, the first solid electrolyte may include more halogen atoms than the second solid electrolyte and thus have improved electron conductivity. In this case, a use of the first solid electrolyte having excellent electron conductivity in the coating layer 15 may decrease resistance of the cathode active material layer 12 including the composite cathode active material particles 14 including the coating layer 15. As a result, the lithium battery 1 including the cathode active material layer 12 may have improved initial capacity and rate capability.

According to an embodiment, the halogen atoms may be fluorine (F), chlorine (Cl), or bromine (Br). For example, the halogen atoms may be chlorine (Cl).

The first solid electrolyte and the second solid electrolyte may each include silicon (Si) and boron (B). When the first solid electrolyte and the second solid electrolyte each include silicon (Si) and boron (B), the cathode active material, the first solid electrolyte, and the second solid electrolyte may be co-sintered at a low temperature. This may allow the cathode to be manufactured more quickly and prevent performance degradation due to the exposure of cathode active material to a high temperature during the manufacturing process.

### Composite Cathode Active Material Particle: Core

The composite cathode active material particles 14 may each include: the core 13 including the lithium transition metal oxide; and the coating layer 15 disposed on at least a portion of the core. In this case, the coating layer 15 may include the first solid electrolyte.

The lithium transition metal oxide included in the core 13 included in the composite cathode active material particles 14 may be a cathode active material capable of reversible absorption and desorption of lithium ions.

Examples of the lithium transition metal oxide may include a lithium cobalt oxide, a lithium nickel oxide, a lithium nickel cobalt oxide, a lithium nickel cobalt aluminum oxide, a lithium nickel cobalt manganese oxide, a lithium manganate, a lithium iron phosphate, or a combination thereof.

Examples of the cathode active material may include a lithium salt of a transition metal oxide having a layered rock salt type structure from among the lithium transition metal oxide described above. The term “layered rock-salt type structure” may be, for example, a structure in which oxygen atom layers and metal atom layers are alternatingly and regularly arranged in <111> direction of a cubic rock salt type structure, such that each atom layer forms a two-dimensional flat plane. The term “cubic rock-salt type” refers to a sodium chloride (NaCl) type structure, which is one of a crystalline structure, in particular, in which face centered cubic lattices (fcc) respectively formed of anions and cations are shifted by a half of the ridge of each unit lattice. Examples of the lithium transition metal oxide having the layered rock-salt type structure may include a ternary lithium transition metal oxide, such as LiNiₓCo_{y}Al_{z}O₂ (NCA) and LiNiₓCo_{y}Mn_{z}O₂ (NCM) (wherein in each of NCA and NCM, x, y, and z are independently 0<x<1, 0<y<1, 0<z<1, and x+y+z=1). When the cathode active material contains a ternary lithium transition metal oxide having the layered rock-salt type structure, energy density and thermal stability of the lithium secondary battery 1 may further improve.

The cathode active material may include, for example, a lithium transition metal oxide represented by Formulas 1 to 6:

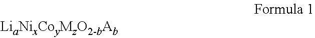

in Formula 1,
1.0≤a≤1.2, 0≤b≤0.2, 0.8≤x<1, 0≤y≤0.3, and 0<z≤0.3, wherein x+y+z=1,
M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and A may be F, S, Cl, Br, or a combination thereof,

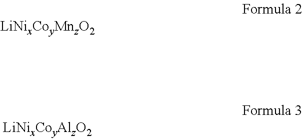

in Formulas 2 and 3, x, y, z, in each Formulas 2 and 3, may independently be 0.8≤x≤0.95, 0≤y≤0.2, 0<z≤0.2, and x+y+z=1,

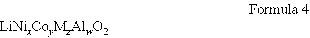

in Formula 4, 0.8≤x≤0.95, 0≤y≤0.2, 0<z≤0.2, 0<w≤0.2, and x+y+z+w=1,

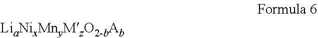

in Formula 6,
1.0≤a≤1.2, 0≤b≤0.2, 0.8≤x<1, 0<y≤0.2, 0≤z≤0.2, and x+y+z=1,
M′ may be niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, A may be F, S, Cl, Br, or a combination thereof.

The core 13 may further include, in addition to the lithium transition metal oxide, for example, a Li₂S-containing composite. Examples of the Li₂S-containing composite may include a Li₂S-carbon composite, a Li₂S-carbon-solid electrolyte composite, a Li₂S-solid electrolyte composite, a Li₂S-metal carbide composite, a Li₂S-carbon-metal carbide composite, and a Li₂S-metal nitride composite, a Li₂S-carbon-metal nitride composite, or a combination thereof.

The Li₂S-carbon composite may include carbon. The carbon may be, for example, any carbon-containing material available as a conductive material in the art. The carbon may be, for example, a crystalline carbon, an amorphous carbon, or a combination thereof. The carbon may be, for example, a fired product of a carbon precursor. The carbon may be, for example, a carbon nanostructure. Examples of the carbon nanostructure may include a one-dimensional carbon nanostructure, a two-dimensional carbon nanostructure, a three-dimensional carbon nanostructure, or a combination thereof. Examples of the carbon nanostructure may include carbon nanotubes, carbon nanofibers, carbon nanotubes, carbon nanorods, graphene, or a combination thereof. The carbon may be, for example, porous carbon or non-porous carbon. The porous carbon may contain, for example, periodic and regular two-dimensional or three-dimensional pores. Examples of the porous carbon may include carbon black such as Ketjen black, acetylene black, Denka black, thermal black, and channel black; and graphite, activated carbon, or a combination thereof. The type of the carbon may be a particle form, a sheet form, a flake shape, and the like, but without being limited to the aforementioned examples, may utilize any suitable material available as carbon in the art. The Li₂S-carbon composite may be prepared by methods including, but not limited to a dry method, a wet method, or a combination thereof. Further, the methods of preparing the Li₂S-carbon composite in the art may include methods such as milling, heat treatment, deposition, and the like, but without being limited to the aforementioned methods, may utilize any suitable method in the art.

The Li₂S-carbon-solid electrolyte composite may include carbon and a solid electrolyte. The carbon is further described in the description of the Li₂S-carbon composite above. The solid electrolyte may be any suitable material available as an ion conductive material in the art. The solid electrolyte may be, for example, an inorganic solid electrolyte. Examples of the solid electrolyte may include a crystalline solid electrolyte, an amorphous solid electrolyte, or a combination thereof. Examples of the solid electrolyte may include a sulfide-based (i.e., sulfide) solid electrolyte, an oxide-based (i.e., oxide) solid electrolyte, or a combination thereof. The sulfide-based solid electrolyte may contain, for example, Li, S, and P, and may optionally further contain a halogen. The sulfide-based solid electrolyte may be selected from among sulfide-based solid electrolytes for use in a solid electrolyte layer. The sulfide-based solid electrolyte may have an ion conductivity of about 1×10⁻⁵ S/cm or greater at room temperature, for example. An oxide-based solid electrolyte may include, for example, Li, O, and a transition metal element, and may optionally further include other elements. The oxide-based solid electrolyte may be, for example, a solid electrolyte having an ion conductivity of about 1×10⁻⁵ S/cm or greater at room temperature. The oxide-based solid electrolyte may be selected from oxide-based solid electrolytes for use in a solid electrolyte layer.

The Li₂S-solid electrolyte composite may include a solid electrolyte. The solid electrolyte is further described in the description of the Li₂S-carbon-solid electrolyte composite above.

The Li₂S-metal carbide composite may include a metal carbide. The metal carbide may be, for example, a two-dimensional metal carbide. The two-dimensional metal carbide may be represented by, for example, Mₙ₊₁CₙTₓ (M is a transition metal, T is a terminal group, wherein T is O, OH or F, n=1, 2, or 3, and X is the number of terminal groups). The two-dimensional metal carbide may be, for example, Ti₂CTₓ, (Ti_{0.5}, Nb_{0.5})₂CTₓ, Nb₂CTₓ, V₂CTₓ, Ti₃C₂Tₓ, (V_{0.5}, Cr_{0.5})₃C₂Tₓ, Ti₃CNTₓ, Ta₄C₃Tₓ, Nb₄C₃Tₓ, or a combination thereof. The surface of two-dimensional metal carbide may be terminated with O, OH, and/or F.

The Li₂S-carbon-metal carbide composite may include carbon and a metal carbide. The carbon is further described in the description of the Li₂S-carbon composite above. The metal carbide is further described in the description of the Li₂S-metal carbide composite.

The Li₂S-metal nitride composite may include a metal nitride. The metal nitride may be, for example, a two-dimensional metal nitride. The two-dimensional metal nitride may be represented by, for example, Mₙ₊₁NₙTₓ (M is a transition metal, T is a terminal group, wherein T is O, OH or F, n=1, 2, or 3, and X is the number of terminal groups). The surface of two-dimensional metal nitride may be terminated with O, OH, and/or F.

The Li₂S-carbon-metal nitride composite may include carbon and a metal nitride. The carbon is further described in the description of the Li₂S-carbon composite above. The metal carbide is further described in the description of the Li₂S-metal nitride composite above.

The lithium transition metal oxide in the core 13 may have, for example, a particle shape such as perfect sphere, oval sphere, and the like. A particle diameter of the lithium transition metal oxide is not particularly limited and may be in a range that is applicable to a lithium transition metal oxide of all-solid secondary batteries in the related art. A content of the lithium transition metal oxide of the cathode layer 10 is not particularly limited and may be in a range that is applicable to a cathode layer of all-solid secondary batteries in the related art.

According to an embodiment, the core 13 may have a particle diameter of about 1 micrometer (μm) to about 10 μm. For example, the core 13 may have an average particle diameter of about 1 μm to about 8 μm, about 1 μm to about 6 μm, about 1 μm to about 4 μm, about 2 μm to about 10 μm, or about 2 μm to about 6 μm.

The diameter of the core 13 may be, for example, a median particle diameter (D50). The median particle diameter (D50) refers to a particle size corresponding to a cumulative volume of 50 vol % in a particle size distribution as measured by laser diffraction method when counting from the smallest particle size.

### Composite Cathode Active Material Particles: Coating Layer

The coating layer 15 may be disposed on at least a portion of the core 13 and may include a first solid electrolyte as a halogen-containing oxide-based solid electrolyte.

According to an embodiment, the first solid electrolyte may include boron (B) and silicon (Si). For example, the first solid electrolyte may include boron (B), silicon (Si), and a halogen. For example, boron (B) may be derived from B₂O₃. For example, silicon (Si) may be derived from SiO₂.

According to an embodiment, the first solid electrolyte may further include lithium (Li) and oxygen (O) in addition to boron (B), silicon (Si), and a halogen. For example, lithium (Li) may be derived from LiCl and/or Li₂O.

According to an embodiment, the first solid electrolyte may further include aluminum (Al), phosphorus (P), germanium (Ge), or a combination thereof. For example, aluminum (Al) may be derived from Al₂O₃. For example, phosphorus (P) may be derived from P₂O₅. For example, germanium (Ge) may be derived from GeO₂.

According to another embodiment, the coating layer 15 may further include other solid electrolytes in addition to the first solid electrolyte. For example, the coating layer may further include Li₂O—ZrO₂ (LZO) and the like, as such other solid electrolytes.

According to an embodiment, the coating layer 15 may have a thickness of about 1 nanometer (nm) to about 3 μm. For example, the coating layer may have a thickness of about 1 nm to about 1,000 nm, about 1 nm to about 800 nm, about 10 nm to about 3 μm, about 50 nm to about 3 μm, about 100 nm to about 3 μm, about 200 nm to about 3 μm, or about 200 nm to about 800 nm.

According to an embodiment, the coating layer 15 may be disposed continuously on an entire surface of the core 13. In this case, as the coating layer 15 is disposed on the entire surface of the core 13, performance degradation due to a side reaction between lithium ions and a lithium transition metal oxide included in the core 13 may be effectively prevented.

According to an embodiment, the coating layer 15 may include a string pattern, a moss pattern, a branch pattern, a spear pattern, or a combination thereof.

### Cathode Active Material Layer: Matrix

According to an embodiment, the cathode active material layer 12 may include the second solid electrolyte 17 having a matrix form in which the composite cathode active material particles 14 are dispersed.

For example, the second solid electrolyte 17 having a matrix form may have a porous structure, and the composite cathode active material particles 14 may be disposed within pores present in the porous structure.

According to an embodiment, the second solid electrolyte 17 having a matrix form may be amorphous. For example, the second solid electrolyte 17 having a matrix form may be amorphous and provide a passage for movement of lithium ions.

According to an embodiment, the second solid electrolyte may include boron (B) and silicon (Si). For example, boron (B) may be derived from B₂O₃. For example, silicon (Si) may be derived from SiO₂.

According to an embodiment, the second solid electrolyte may further include lithium (Li) and oxygen (O) in addition to boron (B) and silicon (Si). For example, lithium (Li) may be derived from LiCl and/or Li₂O.

According to an embodiment, the second solid electrolyte 17 may be free of halogen. In this case, the second solid electrolyte 17 may have excellent ion conductivity, but a relatively low electron conductivity.

According to an embodiment, the second solid electrolyte 17 may further include aluminum (Al), phosphorus (P), germanium (Ge), or a combination thereof. For example, aluminum (Al) may be derived from Al₂O₃. For example, phosphorus (P) may be derived from P₂O₅. For example, germanium (Ge) may be derived from GeO₂.

The second solid electrolyte 17 having a matrix form may further include other solid electrolytes in addition to a halogen-free oxide-based solid electrolyte. The second solid electrolyte 17 having a matrix form may further include an oxide-based solid electrolyte or a sulfide-based solid electrolyte in addition to a halogen-free oxide-based solid electrolyte. The second solid electrolyte 17 having a matrix form may include an oxide-based solid electrolyte in addition to a halogen-free oxide-based solid electrolyte.

Another solid electrolyte included in the second solid electrolyte 17 having a matrix form may be a sulfide-based solid electrolyte. The sulfide-based solid electrolyte is further described in the description of the solid electrolyte layer 30 above.

Another solid electrolyte included in the second solid electrolyte 17 having a matrix form may be an oxide-based solid electrolyte. The oxide-based all-solid electrolyte may be, for example, Li_{1+x+y}AlₓTi₂₋ₓSi_{y}P_{3-y}O₁₂ (0<x<2 and 0≤y<3), BaTiO₃, Pb(ZrₚTi₁₋ₚ)O₃ (PZT, 0≤p≤1 and 0≤q≤1), Pb₁₋ₓLaₓZr_{1-y} Ti_{y}O₃(PLZT) (0≤x<1 and 0≤y<1), Pb(Mg_{1/3}Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2 and 0<y<3), LiₓAl_{y}Ti_{z}(PO₄)₃ (0<x<2, 0<y<1, and 0<z<3), Li_{1+x+y}(AlₚGa₁₋ₚ)ₓ(Ti_{q}Ge_{1-q})₂₋ₓSi_{y}P_{3-y}O₁₂ (0≤x≤1, 0≤y≤1, 0≤p≤1 and 0≤q≤1), LiₓLa_{y}TiO₃ (0<x<2 and 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, or Zr, and x is an integer of 1 to 10), or a combination thereof. The solid electrolyte may be prepared by a sintering method or the like. For example, the oxide-based solid electrolyte may be a garnet-type solid electrolyte of Li₇La₃Zr₂O₁₂ (LLZO), Li₃₊ₓLa₃Zr₂₋ₐMₐO₁₂ (M doped LLZO, M=Ga, W, Nb, Ta, or Al, and x is an integer from 1 to 10), or a combination thereof.

A particle size of the second solid electrolyte 17 as a halogen-free oxide-based solid electrolyte, may be less than or equal to that of the solid electrolyte included in an electrolyte layer 30 described below. For example, the second solid electrolyte 17 as a halogen-free oxide-based solid electrolyte may have a particle diameter of 100% or less, 90% or less, 80% or less, 70% or less, 60% or less, 50% or less, 40% or less, 30% or less, or 20% or less, with respect to a particle diameter of a solid electrolyte included in the electrolyte layer 30. The particle diameter of the second solid electrolyte 17 as a halogen-free oxide-based solid electrolyte may be, for example, a median particle diameter (D50). The median particle diameter (D50) refers to a particle size corresponding to a cumulative volume of 50 vol % in a particle size distribution as measured by laser diffraction method when counting from the smallest particle size.

### Cathode Active Material Layer: First Solid Electrolyte and Second Solid Electrolyte

According to an embodiment, the first solid electrolyte and the second solid electrolyte may each have a glass transition temperature of about 500° C. or less. When the glass transition temperatures of the first solid electrolyte and the second solid electrolyte satisfy the above range, the core 13 including the lithium transition metal oxide, the coating layer 15 including the first solid electrolyte, and the second solid electrolyte 17 having the matrix form may be co-sintered at a low temperature. For example, the core 13 including the lithium transition metal oxide, the coating layer 15 including the first solid electrolyte, and the second solid electrolyte 17 having the matrix form may be co-sintered at a temperature of about 500° C. or less. For example, the sintering temperature of greater than 500° C. may give rise to a defect in the lithium transition metal oxide included in the core 13 during the sintering process, and as a result, may cause deterioration of the capacity and lifespan characteristics of the lithium battery including the cathode.

The first solid electrolyte and the second solid electrolyte included in the cathode according to an embodiment may each have a glass transition temperature of about 450° C. or less. For example, the first solid electrolyte and the second solid electrolyte included in the cathode may each have a glass transition temperature of about 350° C. to about 450° C., about 360° C. to about 430° C., or about 370° C. to about 420° C.

According to an embodiment, a sum of a volume of the first solid electrolyte and a volume of the second solid electrolyte may be about 15 vol % or greater, with respect to a total volume of the cathode active material layer 12. For example, the sum of the volume of the first solid electrolyte and the volume of the second solid electrolyte may be about 15 vol % to about 70 vol %, about 25 vol % to about 60 vol %, about 35 vol % to about 50 vol %, with respect to the total volume of the cathode active material layer 12.

According to an embodiment, the volume of the first solid electrolyte may be 10 vol % or greater, with respect to the total volume of the cathode active material layer. For example, the volume of the first solid electrolyte may be about 10 vol % to about 60 vol %, with respect to the total volume of the cathode active material layer.

According to an embodiment, the volume of the second solid electrolyte may be 5 vol % or greater, with respect to the total volume of the cathode active material layer. For example, the volume of the first solid electrolyte may be about 5 vol % to about 10 vol %, with respect to the total volume of the cathode active material layer.

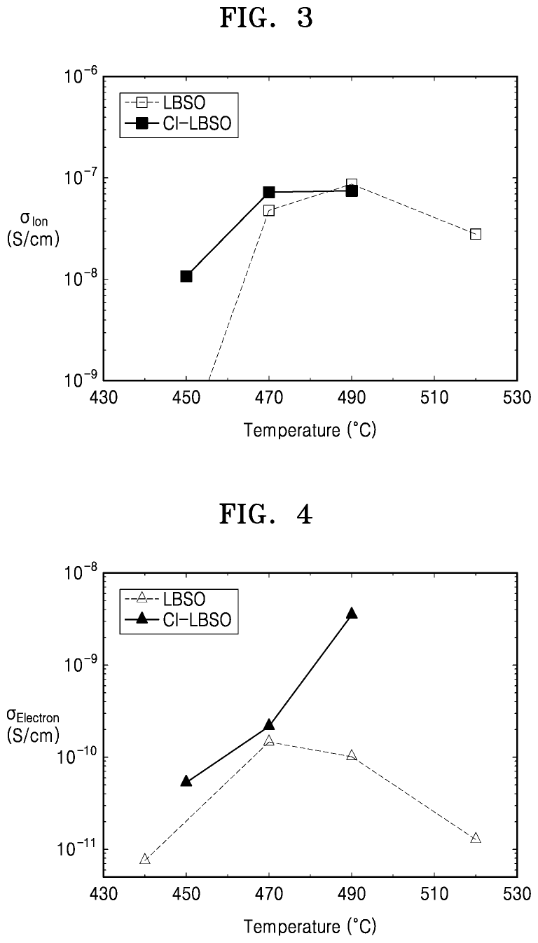

FIG. 3 is a graph showing an ion conductivity according to sintering temperature of a halogen-containing oxide-based solid electrolyte and a halogen-free oxide-based solid electrolyte.

Referring to FIG. 3, the first solid electrolyte as a halogen-containing oxide-based solid electrolyte, and the second solid electrolyte as a halogen-free oxide-based solid electrolyte may each have an ion conductivity of about 1×10⁻⁸ S/cm or greater, for example, about 1×10⁻⁸ S/cm to about 1×10⁻¹ S/cm, about 1×10⁻⁷ S/cm to about 1×10⁻² S/cm, or about 1×10⁻⁶ S/cm to about 1×10⁻³ S/cm.

According to an embodiment, the first solid electrolyte, as a halogen-containing oxide-based solid electrolyte, may have an ion conductivity of about 1×10⁻⁸ S/cm or greater when sintered in a temperature range of about 450° C. to about 490° C. For example, the first solid electrolyte may have an ionic conductivity of about 1×10⁻⁷ S/cm or greater.

According to an embodiment, the second solid electrolyte, which is a halogen-free oxide-based solid electrolyte, may have an ion conductivity of about 1×10⁻⁸ S/cm or greater when sintered in a temperature range of about 450° C. to about 490° C. For example, the second solid electrolyte may have an ionic conductivity of about 1×10⁻⁷ S/cm or greater.

According to an embodiment, the second solid electrolyte may have an ion conductivity greater than the ion conductivity of the first solid electrolyte. In this case, lithium ions may pass through the second solid electrolyte having a matrix form more easily, and as the first solid electrolyte having a relatively lower ion conductivity is disposed on the surface of the core 13 including a lithium transition metal oxide, performance decrease due to side reactions between lithium ions and cathode active materials may be prevented.

FIG. 4 is a graph showing an electron conductivity according to sintering temperature of a halogen-containing oxide-based solid electrolyte and a halogen-free oxide-based solid electrolyte.

Referring to FIG. 4, the first solid electrolyte as a halogen-containing oxide-based solid electrolyte, and the second solid electrolyte as a halogen-free oxide-based solid electrolyte may each have an electronic conductivity of about 1×10⁻¹⁰ S/cm or greater.

According to an embodiment, the first solid electrolyte, as a halogen-containing oxide-based solid electrolyte, may have an ion conductivity of about 1×10⁻⁸ S/cm or greater when sintered in a temperature range of about 450° C. to about 490° C. For example, the first solid electrolyte may have an ionic conductivity of about 1×10.7 S/cm or greater.

According to an embodiment, the second solid electrolyte as a halogen-free oxide-based solid electrolyte may have an ion conductivity of about 1×10⁻⁸ S/cm or greater when sintered in a temperature range of about 450° C. to about 490° C. For example, the second solid electrolyte may have an ion conductivity of about 1×10⁻⁷ S/cm or greater.

According to an embodiment, the first solid electrolyte may have an electron conductivity greater than the electron conductivity of the second solid electrolyte. In this case, as the electron conductivity of the first solid electrolyte included in the coating layer 15 disposed on the surface of the core 13 including a lithium transition metal oxide is greater than the electron conductivity of the second solid electrolyte 17 having a matrix form, electrons may more easily pass through the coating layer 15 including the first solid electrolyte to react with lithium ions passed through the second solid electrolyte more easily. As a result, the resistance of the cathode 10 may decrease.

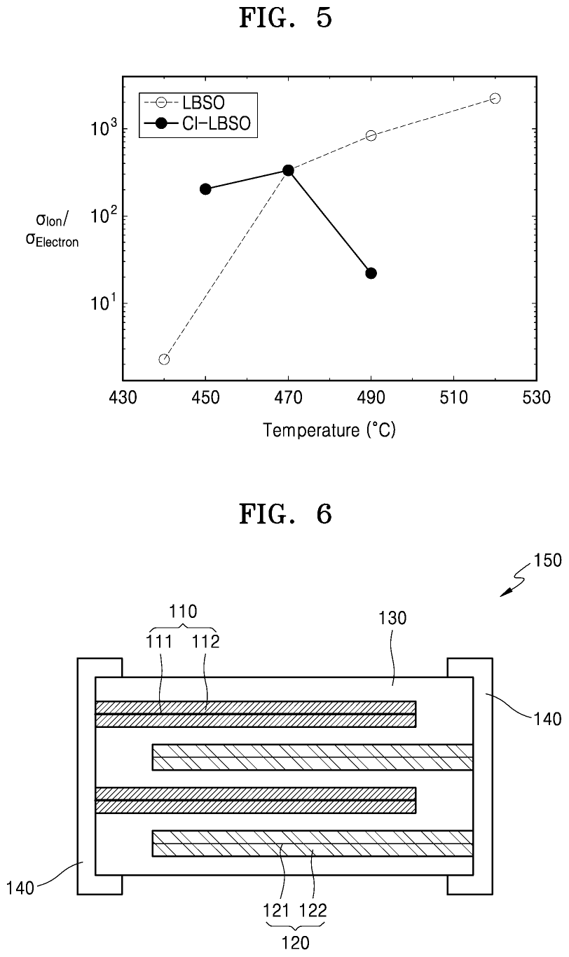

FIG. 5 is a graph showing a ratio of ion conductivity to electron conductivity according to sintering temperature of a halogen-containing oxide-based solid electrolyte and a halogen-free oxide-based solid electrolyte.

Referring to FIG. 5, the ratio of ion conductivity to electron conductivity of each of the first solid electrolyte and the second solid electrolyte may be about 1,000 or less.

According to an embodiment, the ratio of ion conductivity to electron conductivity of the first solid electrolyte as a halogen-containing oxide-based solid electrolyte may be about 1,000 or less when sintered in a temperature range of about 450° C. to about 490° C. For example, the ratio of ion conductivity to electron conductivity of the first solid electrolyte may be about 100 or less, about 50 or less, or about 30 or less. In an aspect, the ratio of ion conductivity to electron conductivity of the first solid electrolyte may be about 5 to about 100, about 10 to about 100, or about 15 to about 100.

According to an embodiment, the ratio of ion conductivity to electron conductivity of the second solid electrolyte as a halogen-free oxide-based solid electrolyte may be about 1,000 or less when sintered in a temperature range of about 450° C. to about 490° C. For example, the ratio of ion conductivity to electron conductivity of the second solid electrolyte may be about 100 to about 1,000.

According to an embodiment, the ratio of ion conductivity to electron conductivity of the first solid electrolyte may be less than the ratio of ion conductivity to electron conductivity of the second solid electrolyte. In this case, as the first solid electrolyte included in the coating layer 15 disposed on the surface of the core 13 including a lithium transition metal oxide has excellent electron conductivity and the second solid electrolyte having a matrix form has excellent ion conductivity, the movement of lithium ions inside the cathode 10 may be facilitated, and the movement of electrons between lithium ions introduced into the cathode 10 and the lithium transition metal oxide included in the core 13 may be improved, thus decreasing the resistance of the cathode 10.

The cathode active material layer 12 may further include a solid electrolyte in addition to the above-described first solid electrolyte and second solid electrolyte. The cathode active material layer 12 may include an oxide-based solid electrolyte or a sulfide-based solid electrolyte. The cathode active material layer 12 may further include an oxide-based solid electrolyte.

### Cathode Active Material Layer: Binder

The cathode active material layer 12 may include a binder. The binder may be, for example, styrene butadiene rubber (SBR), polytetrafluoroethylene, polyvinylidene fluoride, polyethylene, and the like, but is not limited to the aforementioned materials, and may be any suitable material available as a binder in the art.

### Cathode Active Material Layer: Conductive Material

The cathode active material layer 12 may include a conductive material. Examples of the conductive material may include graphite, carbon black, acetylene black, Ketjen black, carbon fibers, metal powder, and the like. However, the conductive material is not limited to the aforementioned materials and may be any suitable material available as a conductive material in the art.

According to an embodiment, the cathode active material layer 12 may not include a linear conductive material.

### Cathode Active Material Layer: Other Additives

The cathode active material layer 12 may further include, for example, additives such as a filler, a coating agent, a dispersing agent, and an ion-conducting agent in addition to the cathode active material, solid electrolyte, binder, and conductive material described above.

For the filler, coating agent, dispersing agent, and ion-conducting agent that may be included in the cathode active material layer 12, any suitable material used in electrodes of all-solid secondary batteries may be used.

### Cathode Layer: Cathode Current Collector

For example, the cathode current collector 11 may comprise a plate, a foil, or the like, comprising indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. The cathode current collector 11 may be omitted. The cathode current collector 11 may have a thickness of, for example, about 1 μm to about 100 μm, about 1 μm to about 50 μm, about 5 μm to about 25 μm, or about 10 μm to about 20 μm.

### Cathode Layer

According to an embodiment, the cathode 10 may have a thickness of about 1 nm to about 100 μm. The cathode 10 may have a thickness of, for example, about 1 μm to about 75 μm, about 1 μm to about 50 μm, about 1 μm to about 25 μm, about 1 μm to about 10 μm, about 2 μm to about 100 μm, about 4 μm to about 100 μm, about 5 μm to about 100 μm, about 2 μm to about 25 μm, or about 5 μm to about 10 μm.

According to an embodiment, the cathode 10 may have a Young's modulus of about 10 gigapascals (GPa) to about 100 GPa. According to an embodiment, the cathode 10 may have a Young's modulus of about 10 GPa to about 90 GPa, about 10 GPa to about 80 GPa, about 20 GPa to about 100 GPa, about 40 GPa to about 100 GPa, about 50 GPa to about 100 GPa, about 60 GPa to about 100 GPa, about 50 GPa to about 90 GPa, or about 60 GPa to about 80 GPa. For example, Young's modulus of the cathode 10 may be measured using an ultrasonic technique. For example, Young's modulus of the cathode 10 may be measured through a pulse-echo method using ultrasonic waves.

### Electrolyte Layer

### Electrolyte Layer: Third Solid Electrolyte

Referring to FIG. 1, the electrolyte layer 30 may be disposed between the cathode layer 10 and the anode layer 20. The electrolyte layer 30 may include a solid electrolyte (e.g., third solid electrolyte).

According to an embodiment, the solid electrolyte may be the halogen-free oxide-based solid electrolyte described above. According to an embodiment, the solid electrolyte included in the electrolyte layer 30 may include the same composition as the second solid electrolyte 17 described above. For example, the electrolyte layer 30, due to containing an oxide-based solid electrolyte free of halogen, may have excellent ion conductivity but a decreased electron conductivity.

According to an embodiment, the solid electrolyte may further include the halogen-containing oxide-based solid electrolyte described above.

### Solid Electrolyte Layer: Binder

The electrolyte layer 30 may further include, for example, a binder. Examples of the binder included in the electrolyte layer 30 may include styrene butadiene rubber (SBR), polytetrafluoroethylene, polyvinylidene fluoride, polyethylene, and the like. However, the binder is not limited to the aforementioned materials and may be any suitable binder available in the art. The binder in the electrolyte layer 30 may be identical to or different from a binder included in the cathode active material layer 12 and the anode active material layer 22. The binder may be omitted.

The binder included in the solid electrolyte layer may include, for example, a conductive binder and/or a non-conductive binder. Examples of a conductive binder may include ion-conductive binders and/or electron-conductive binders. Binders having both ion conductivity and electron conductivity belong to both ion-conductive binders and electron-conductive binders.

The binder included in the electrolyte layer 30 may include, for example, a first binder. The first binder may be, for example, a dry binder. The dry binder may be, for example, a binder that is not impregnated, dissolved or dispersed in a solvent. The dry binder may be, for example, a binder that does not contain or come into contact with a solvent.

The first binder may be, for example, a fibrillized binder. The fibrillized binder may serve as a fibrous matrix for supporting a plurality of inorganic particles and sulfide-based solid electrolyte particles included in the solid electrolyte layer and binding these particles together. The fibrous form of the fibrillized binder may be confirmed from, for example, a scanning electron microscopic image of a cross section of an electrode. The fibrillized binder may have an aspect ratio of, for example, about 10 or greater, about 20 or greater, about 50 or greater, or about 100 or greater. The first binder may be, for example, polytetrafluoroethylene (PTFE), a polyvinylidene fluoride-hexapropylene (PVDF-HFP) copolymer, or the like; however, without being necessarily limited thereto, the first binder may utilize any suitable fibrillized binder available for use in the preparation of dry compositions. The first binder may include a fluorine-based (e.g., fluorine) binder in particular. Examples of the fluorine-based binder may include polytetrafluoroethylene (PTFE).

The binder included in the electrolyte layer 30 may further include, for example, a second binder. The second binder may be, for example, a dry binder. The description of the dry binder is the same as in the description of the first binder above.

The second binder may be, for example, a non-fibrillized binder. The non-fibrillized binder may support sulfide-based solid electrolyte particles and inorganic particles included in the solid electrolyte layer and may serve as a binding site that binds these particles together. For example, a scanning electron microscopic image of a cross section of an electrode may show that the non-fibrillized binder does not have a fibrillized form but is disposed in a particulate form. The non-fibrillized binder may have an aspect ratio of, for example, about 5 or less, about 3 or less, or about 2 or less. Examples of the second binder may include polyvinylidene fluoride (PVDF), polyvinyl alcohol, polyacrylonitrile, carboxymethylcellulose (CMC), starch, hydroxypropylcellulose, cellulose, poly Vinylpyrrolidone, polyethylene, polypropylene, ethylene-propylene-diene polymer (EPDM), sulfonated-EPDM, styrene butadiene rubber (SBR), a fluororubber, or a copolymer thereof; however, the second binder is not necessarily limited to the aforementioned examples and may be any suitable binder available for use in the manufacturing of dry electrodes. The second binder may include a fluorine-based binder, in particular. Examples of the fluorine-based binder may include polyvinylidene fluoride (PVDF).

An amount of the binder included in the electrolyte layer 30 may be, for example, 0 weight percent (wt %) to about 10 wt %, 0 wt % to about 5 wt %, or 0 wt % to about 3 wt %, with respect to the total weight of the solid electrolyte layer. Inclusion of the binder in the solid electrolyte layer in an amount in the above range may improve the binding force of the solid electrolyte layer and allow the all-solid secondary battery to maintain high energy density.

The electrolyte layer 30 may be, for example, a self-standing film. For example, the solid electrolyte layer may retain a film form without a support. Therefore, the solid electrolyte layer may be prepared as a separate self-standing film, which is then disposed between the cathode layer and the anode layer. For example, the solid electrolyte layer may be free of residual processing solvent.

### Anode Layer

### Anode Layer: Anode Current Collector

The anode current collector 21 may be formed of a material that does not react with lithium, that is, does not form an alloy or a compound with lithium. Examples of the material forming the anode current collector 21 may include carbon (C), copper (Cu), stainless steel (SUS), titanium (Ti), iron (Fe), cobalt (Co), nickel (Ni), and the like. However, the material forming the anode current collector 21 is not necessarily limited to the aforementioned examples but may be any suitable material available as an electrode current collector in the art. The anode current collector 21 may be formed of one of the aforementioned metals, an alloy of two or more metals thereof, or a coating material. The anode current collector 21 may be, for example, a plate shape or a foil shape.

The anode current collector 21 may further include, for example, a thin film containing an element capable of forming an alloy with lithium on the anode current collector 21. The thin film may be positioned between the anode current collector 21 and the anode active material layer 22. The thin film may include, for example, an element capable of forming an alloy with lithium. The element capable of forming an alloy with lithium may be, for example, gold, silver, zinc, tin, indium, silicon, aluminum, bismuth, or the like, but is not necessarily limited thereto and may be any suitable element in the art that can form an alloy with lithium. The thin film may comprise one of the aforementioned metals or may comprise an alloy of various kinds of metals. When the thin film is disposed on the anode current collector 21, for example, the precipitation form of the second anode active material layer being precipitated between the thin film (not illustrated) and the anode active material layer 22 may be further flattened, and cycle characteristics of the lithium secondary battery 1 may further improve.

For example, the thin film may have a thickness of about 1 nm to about 10 μm, about 10 nm to about 5 μm, or about 100 nm to about 3 μm. If the thickness of the thin film is less than 1 nm, it may be difficult to achieve functions attributable to the thin film. If the thickness of the thin film is excessively large, it may decrease the actual energy density of the lithium secondary battery 1 and cause deterioration of cycle characteristics of the lithium secondary battery 1. The thin film may be positioned on the anode current collectors 21 by a screen-printing method, a vacuum deposition method, a sputtering method, a plating method or the like, but without being limited to the aforementioned methods, any suitable method available in the art that is capable of forming the thin film may be used.

### Anode Layer: Anode Active Material

Referring to FIG. 1, the anode layer 20 may include an anode current collector 21; and an anode active material layer 22 disposed on the anode current collector. For example, the anode active material layer 22 may include an anode active material.

The anode active material included in the anode active material layer 22 may include, for example, a carbonaceous anode active material, an anode active material forming an alloy or a compound with lithium, or a combination thereof.

For example, the anode active material may utilize a material capable of adsorbing and desorbing lithium ions. The anode active material may include a carbon-based material, an anode active material that forms an alloy or compound with lithium, or any combination thereof.

According to an embodiment, the carbon-based material may include graphite or non-graphitic carbon. For example, the anode active material may include an amorphous carbon. Examples of the amorphous carbon may include carbon black (CB), acetylene black (AB), furnace black (FB), Ketjen black (KB), graphene, or any combination thereof. The amorphous carbon as carbon with no crystalline structure or an extremely low degree of crystallinity may be distinguished from crystalline carbon or graphitic carbon.

The anode active material that forms an alloy or a compound with lithium may include an alloyable element of gold (Au), platinum (Pt), palladium (Pd), silicon (Si), silver (Ag), aluminum (Al), bismuth (Bi), tin (Sn), zinc (Zn), or a combination thereof. For example, nickel (Ni) does not form an alloy with lithium, and as such may not be included in the anode active material that forms an alloy or compound with lithium.

The anode active material layer 22 may include a single type of the above anode active materials or may include a mixture of multiple different types of such anode active materials. For example, the anode active material layer 22 may include amorphous carbon alone or may include a metal of gold (Au), platinum (Pt), palladium (Pd), silicon (Si), silver (Ag), aluminum (Al), bismuth (Bi), tin (Sn), zinc (Zn), or a combination thereof. Alternatively, the anode active material layer 22 may include a mixture of amorphous carbon with gold (Au), platinum (Pt), palladium (Pd), silicon (Si), silver (Ag), aluminum (Al), bismuth (Bi), tin (Sn), zinc (Zn), or a combination thereof.

According to an embodiment, a mixing ratio of amorphous carbon to the metal(s) described herein, such as gold in such a mixture may be about 10:1 to about 1:2, about 5:1 to about 1:1, or about 4:1 to about 2:1 in weight ratio, but without being necessarily limited thereto, the mixing ratio may be selected according to required characteristics of a lithium battery 1. As the anode active material has the above compositions, cycle characteristics of the lithium battery 1 may be further improved.

The anode active material included in the anode active material layer 22 may have, for example, a particle shape. The anode active material having a particle form may have a particle size (D50) of, for example, about 20 μm or less, about 10 μm or less, about 7 μm or less, or about 5 μm or less. The anode active material having a particle form may have a particle size of, for example, about 1 μm to about 20 μm, about 2 μm to about 10 μm, and about 5 μm to about 10 μm. As the anode active material satisfies the above particle diameter range, reversible absorption and/or desorption of lithium during charging/discharging may be further facilitated. The particle diameter of the anode active material may be, for example, a median particle diameter (D50) as measured by a laser-type particle size distribution analyzer.

### Anode Layer: Binder

Referring to FIG. 1, the anode active material layer 22 may further include a binder. The anode active material layer 22 may include, for example, an anode active material and a binder.

The binder included in the first anode active material layer 22 may be, for example, styrene butadiene rubber (SBR), polytetrafluoroethylene, polyvinylidene fluoride, polyethylene, a vinylidene fluoride/hexafluoropropylene copolymer, polyacrylonitrile, polymethylmethacrylate, or the like. However, the binder is not necessarily limited to the aforementioned materials and may be any suitable material available as a binder in the art. The binder may be composed of a single type of binder, or different types of binders.

### Lithium Battery

According to an embodiment, the cathode may be applied to a lithium battery. According to an embodiment, the cathode may be applied to a solid lithium battery including a solid electrolyte.

The lithium battery may be a lithium ion battery, an all-solid battery, or a multilayer ceramic (MLC) battery. For example, the lithium battery may be a multilayer ceramic battery (MLC).

### Multilayer Ceramic (MLC) Battery

A multilayer ceramic battery may include, for example, a plurality of cathode layers; a plurality of anode layers alternately disposed between the plurality of cathode layers; and an electrolyte layer alternately disposed between the plurality of cathode layers and the plurality of anode layers. For example, the cathode layer may include a second solid electrolyte having a matrix form; composite cathode active material particles disposed in the second solid electrolyte; and a cathode active material layer including the second solid electrolyte having a matrix form in which the composite cathode active material particles are dispersed.

A multilayer ceramic battery may be, for example, a sintered product of a laminate in which a cathode active material precursor, an anode active material precursor, and a solid electrolyte precursor are sequentially deposited, or may be a sintered product of a laminate having a cathode active material, an anode active material, and a solid electrolyte sequentially deposited. The multilayer ceramic battery may be provided with a multilayer structure in which a plurality of unit cells are stacked such that a cathode active material layer and an anode active material layer face each other, wherein each unit cell is disposed in a sequential and continuous manner: the cathode layer including a cathode active material layer; a solid electrolyte layer; and an anode layer including an anode active material layer. The multilayer ceramic battery may further include, for example, a cathode current collector and/or an anode current collector. In a case in which the multilayer ceramic battery includes a cathode current collector, the cathode active material layer described above may be disposed on both sides of the cathode current collector. In a case in which the multilayer ceramic battery includes an anode current collector, the above-described anode active material layer may be disposed on both sides of the anode current collector. As the multilayer ceramic battery further includes a cathode current collector and/or an anode current collector, high-rate characteristics of the battery may be further improved. In the multilayer ceramic battery, unit cells are stacked by providing a current collector layer on one or both of the uppermost layer and the lowermost layer of a stack, or by inserting a metal layer into the stack. The multilayer ceramic battery or thin film (e.g., film) battery may be, for example, a small or micro cell that can be applied as, for example, a power source for internet of things (IOT) applications and a power source for wearable devices. A multilayer ceramic battery or a thin film battery can also be applied to medium- or large-sized batteries such as electric vehicles (EVs) and energy storage systems (ESSs).

The anode included in the multilayer ceramic battery may include, for example, an anode active material of lithium metal phosphates, lithium metal oxides, metal oxides, or a combination thereof. For example, the anode active material may be a compound of Li_{4/3}Ti_{5/3}O₄, LiTiO₂, LiM1ₛM2ₜOᵤ (M1 and M2 are transition metals, wherein s, t, and u are each any positive number), TiOₓ (0<x≤3), LiₓV₂(PO₄)₃ (0<x≤5), or a combination thereof. The anode active material may be, in particular, Li_{4/3}Ti_{5/3}O₄, LiTiO₂, or the like.

The cathode included in the multilayer ceramic battery may include the above-described cathode active material layer. The cathode active material layer may include: composite cathode active material particles that include a cathode active material and a coating layer including a first solid electrolyte and disposed on at least a portion of the cathode active material surface; and a matrix including a second solid electrolyte and having the composite cathode active material particles dispersed therein.

The current collector layer may function as a cathode current collector and/or an anode current collector. The current collector layer may comprise carbon (C) or a metal of Ni, Cu, Ag, Pd, Au, Pt, or a combination thereof. The current collector layer may be made of, for example, an alloy of Ni, Cu, Ag, Pd, Au, Pt, or a combination thereof. The alloy may be, for example, an alloy of two or more of Ni, Cu, Ag, Pd, Au, Pt, or a combination thereof. The alloy may be, for example, an Ag/Pd alloy. Such a metal and alloy may be a single type or a mixture of two or more types. The current collector layer as the cathode current collector and the current collector layer as the anode current collector may use the same material or may use different materials from each other. Since an alloy or mixed powder containing Ag and Pd by adjusting its mixing ratio, can adjust its melting point to any melting point between the melting point of silver (962° C.) and the melting point of palladium (1,550° C.), the melting point may be adjusted to the batch firing temperature, and due to a high electron conductivity, increase in battery internal resistance may be suppressed.

The solid electrolyte may be free of halogen. For example, the solid electrolyte may be an oxide-based solid electrolyte. The oxide-based solid electrolyte may include a second solid electrolyte. For example, the solid electrolyte may further include a lithium compound of Li_{3.25}Al_{0.25}SiO₄, Li₃PO₄, LiPₓSi_{y}O_{z} (in the formula, x, y, and z each are any positive number), or a combination thereof. The solid electrolyte may further include, for example, Li_{3.5}P_{0.5}Si_{0.5}O₄.

FIG. 6 is a schematic cross-sectional view of a multilayer ceramic (MLC) battery according to an embodiment. Referring to FIG. 6, a cathode active material layer 112 may be disposed on both sides of a cathode current collector 111 to form a cathode 110. An anode electrode 120 may be formed by depositing an anode active material layer 122 on both sides of an anode current collector 121. A solid electrolyte 130 may be disposed between the cathode 110 and the anode 120. An external electrode 140 may be formed at both ends of a battery body 150. The external electrode 140 may be connected to the cathode 110 and the anode 120, each of which tip portion is exposed outside the battery body 150, to act as an external terminal that electrically connects the cathode 110 and the anode 120 to an external element. One end of one of a pair of external electrodes 140 may be connected to the cathode 110 exposed to the outside of the battery body 150, and the other one of the pair of external electrodes 140 may have the other end thereof connected to the anode 120 exposed to the outside of the battery body 150. A multilayer ceramic (MLC) battery 150 may be prepared by sequentially depositing an oxide electrode and a solid electrolyte, followed by heat-treating the oxide electrode and the solid electrolyte at the same time.

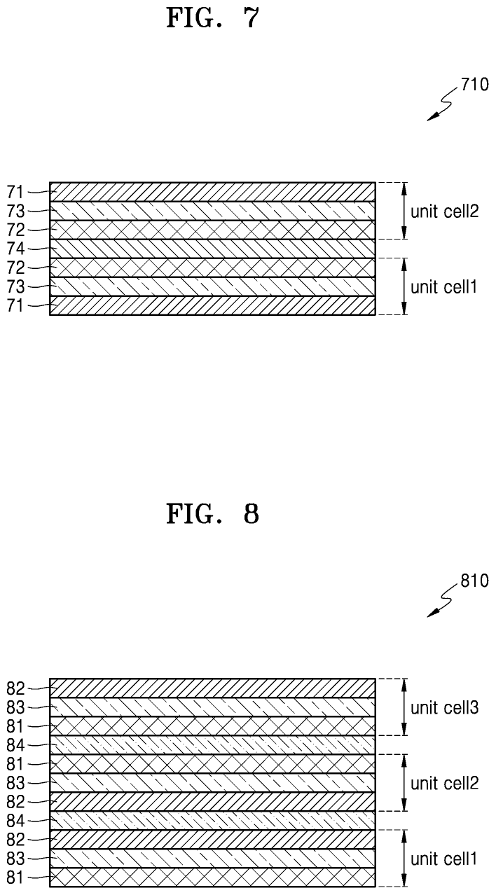

FIGS. 7 and 8 schematically show a cross-sectional structure of a multilayer ceramic battery according to another embodiment. As shown in FIG. 7, in the multilayer ceramic battery 710, a unit cell 1 and a unit cell 2 may be disposed on an internal current collector layer 74. Each of the unit cell 1 and the unit cell 2 may comprise a cathode layer 71, a solid electrolyte layer 73, and an anode layer 72, sequentially stacked. The unit cell 1, the unit cell 2, and the internal (e.g., inner) current collector layer 74 may be stacked such that the anode layer 72 of the unit cell 2 is adjacent to one side of the inner current collector layer 74 (top surface in FIG. 7) and the anode layer 72 of the unit cell 1 is adjacent to the other side of the inner current collector layer 74 (bottom surface in FIG. 7). The inner current collector layer 74 is illustrated in FIG. 7 as being positioned in contact with the anode layer 72 of each of the unit cell 1 and the unit cell 2, but may also be positioned in contact with the cathode layer 71 of each of the unit cell 1 and the unit cell 2. The inner current collector layer 74 may include an electronically conductive material. The inner current collector layer 74 may further include an ionic conductive material. Further inclusion of the ionic conductive material may improve voltage stabilization characteristics. Since the same polarity is positioned on both sides of the inner current collector layer 74 in a multilayer ceramic battery 710, by inserting the inner current collector layer 74, a monopolar-type multilayer ceramic battery 710 having a plurality of unit cells connected in parallel may be obtained. As a result, a high-capacity multilayer ceramic battery 710 may be obtained. Since in the multilayer ceramic battery 710, the inner current collector layer 74 inserted between the unit cell 1 and the unit cell 2 contains an electron conducting material, two adjacent unit cells may be electrically connected in parallel, and at the same time, the cathode layer 71 or anode layer 72 in the two adjacent unit cells may be connected in an ion-conducting manner. As a result, electric potentials of adjacent anode layers 71 or cathode layers 72 can be averaged through the internal current collector layer 74, a stable output voltage may be obtained. In addition, the single cells constituting the multilayer ceramic battery 710 may be electrically connected in parallel without an external current collecting member such as a tab. Accordingly, the multilayer ceramic battery 710 having excellent space efficiency and cost-effectiveness may be obtained. Referring to FIG. 8, a lamination may contain a cathode layer 81, an anode layer 82, a solid electrolyte layer 83, and an inner current collector layer 84. The lamination may be stacked and thermally compressed to form a multilayer ceramic battery laminate 810. The cathode layer 81 may consist of a single sheet of a cathode layer sheet. The anode layer 82 may consist of two sheets of an anode layer sheet.

### Preparation of Cathode

In an aspect, a method of preparing a cathode, the method comprises:
providing a composite cathode active material particle comprising a core, and a coating layer disposed on at least a portion of the core, wherein the core comprises a lithium transition metal oxide, and the coating layer comprises a first solid electrolyte, wherein the first solid electrolyte is a halogen-containing oxide solid electrolyte;
impregnating the composite cathode active material particle into a matrix comprising second solid electrolyte, wherein the second solid electrolyte is a halogen-free oxide solid electrolyte to form an impregnated matrix; and
heat-treating the impregnated matrix to form a cathode active material layer to form the cathode, and wherein the first solid electrolyte and the second solid electrolyte each comprise silicon and boron.

The method of preparing the cathode according to an embodiment may include:
preparing composite cathode active material particles, each including a core and a coating layer disposed on at least a portion of the core;
impregnating the composite cathode active material particles into the second solid electrolyte; and heat-treating the matrix having the composite cathode active material particles impregnated therein.

For example, the cathode active material layer may include composite cathode active material particles that include the cathode active material and the coating layer including the first solid electrolyte and disposed on at least the portion of the cathode active material surface; and the matrix including the second solid electrolyte and having the composite cathode active material particles dispersed therein, wherein the first solid electrolyte may include a halogen, the second solid electrolyte may be free of halogen, and the first solid electrolyte and the second solid electrolyte may each include silicon (Si) and boron (B). As a result, the lithium battery including the cathode may have a reduced internal resistance and thus, may have an increased initial capacity and an improved rate capability.

According to an embodiment, the heat-treating (e.g., heat-treatment) may comprises heat-treating at a temperature of about 500° C. or less. Since the glass transition temperature of the first solid electrolyte and the second solid electrolyte is about 500° C. or less, the first solid electrolyte and the second solid electrolyte may be co-sintered with the lithium transition metal oxide included in the core at a temperature of about 500° C. or less. In this case, a lithium battery including such a cathode may be manufactured more rapidly. In addition, since the sintering temperature corresponds to about 500° C. or less, damage of the cathode active material resulting from exposure to a temperature of about 500° C. or greater may be effectively prevented.

According to an embodiment, the sintering temperature may be about 450° C. to about 500° C., about 460° C. to about 500° C., about 470° C. to about 500° C., about 450° ° C. to about 490° C., about 460° C. to about 490° ° C., about 470° C. to about 490° C., or about 475° C. to about 490° C.

### Preparation of Lithium Battery

A lithium battery 1 may be prepared, for example, through a process in which the cathode layer 10, the anode layer 20, and the solid electrolyte layer 30 are each prepared as a paste, and then prepared into a green body by casting, screen-printing and lamination, followed by heat-treating the layers at the same time.

### Preparation of Third Solid Electrolyte

The electrolyte layer 30 may be prepared by a third solid electrolyte. For example, the third solid electrolyte may be prepared by a solid electrolyte formed of the above-described second solid electrolyte material.

The third solid electrolyte may be prepared by treating starting materials through a melt quenching method, a mechanical milling method, or the like, but without being necessarily limited to these methods, any suitable method in the art available as the above-described method of preparing a second solid electrolyte may be used. For example, when a melt quenching method is to be used, starting materials including LiCl, Li₂O, B₂O₃, SiO₂, etc. in specific amounts are mixed and formed into pellets, and the pellets are reacted under vacuum at a reaction temperature and then quenched to form the second solid electrolyte material. In addition, the reaction temperature of the mixture of LiCl, Li₂O, B₂O₃, and SiO₂ may be, for example, about 400° C. to about 1,200° C., or about 800° C. to about 900° C. The reaction time may be about, for example, about 0.1 hour to about 12 hours, or about 1 hour to about 12 hours. The rapid cooling temperature of the reactants may be about 10° C. or less or 0° C. or less, and the quenching rate thereof may be about 1 ºC/sec to about 10,000° C./sec, or 1° C./sec to about 1,000° C./sec. As a rapid cooling method, methods such as air cooling, pressing hot melts with a metal plate or the like, plunging hot melts into mercury, a strip furnace, splat quenching, and a roller quenching method (single or twin) may be applied. For example, when the mechanical milling method is used, by using a ball mill or the like, the preparation of the second solid electrolyte material may be achieved by conducting a reaction on starting materials such as LiCl, Li₂O, B₂O₃, and SiO₂ under stirring. The stirring speed and stirring time of the mechanical milling method are not particularly limited, but the faster the stirring speed, the faster the formation rate of the second solid electrolyte material, and the longer the stirring time, the greater the conversion rate of the raw materials into the second solid electrolyte material. Subsequently, the mixed materials obtained by a melt quenching method, a mechanical milling method, or the like may be heat-treated at a predetermined temperature and then ground to thereby prepare a solid electrolyte in a particle form. In cases in which the solid electrolyte has glass transition characteristics, the solid electrolyte can be transformed from an amorphous phase to a crystalline phase by a heat-treatment. As an additional method for preparing a solid electrolyte, a sol-gel method, a vapor deposition method, a sputtering method, a laser ablation method, a PLD (pulsed laser deposition) method, a plasma method, and the like, may be used.

Subsequently, the prepared oxide solid electrolyte may be powderized. The powderization may be carried out by mechanical milling. For the mechanical milling, a dry milling technique may be used, or a solvent may be added as necessary. The solvent may include, for example, acetone, ethanol, water, ethylene glycol, isopropanol, or a combination thereof. The mechanical milling may be performed by a suitable method known in the art. For example, the milling may utilize a ball mill, an air jet mill, a bead mill, a roll mill, a planetary mill, or the like.

The halogen-free oxide-based solid electrolyte used in the preparation of the electrolyte layer 30 may have an average particle diameter of greater than about 1 μm, for example. The halogen-free oxide-based solid electrolyte used in the preparation of the cathode active material layer 12 may have an average particle diameter of, for example, about 1.1 μm to about 5 μm, about 2 μm to about 5 μm, or about 2 μm to about 4 μm. The average particle diameter of the second solid electrolyte may be a volume-based median diameter (D50) as measured using a laser-type particle size distribution analyzer.

Additionally, the oxide-based solid electrolyte used as the first solid electrolyte may have an average particle diameter of, for example, about 50 nm to about 5 μm, or about 200 nm to about 1 μm. The average particle diameter of the first solid electrolyte may be a volume-based median diameter (D50) measured using a laser-type particle size distribution analyzer.

### Preparation of Solid Electrolyte Sheet

The solid electrolyte green sheet may be prepared as follows. Solid electrolyte powder, an organic binder, and the like may be mixed together, and the resulting mixture may be dispersed in an organic solvent. The solvent may utilize, without being limited to, any one or a mixture of two or more selected from among lower alcohols containing 4 or fewer carbon atoms such as methanol, ethanol, isopropanol, n-butanol, sec-butanol, t-butanol, and the like; aliphatic glycols such as ethylene glycol, propylene glycol(1,3-propanediol), 1,3-propanediol, 1,4-butanediol, 1,2-butanediol, 1,3-butanediol, 2-methyl-1,3-propanediol, and the like; ketones such as methyl ethyl ketone and the like; amines such as dimethyl ethyl amine and the like; and alicyclic alcohols such as terpineol and the like.

A solid electrolyte sheet may be prepared by uniformly coating or printing the dispersed slurry onto a substrate. As the substrate, for example, a polymer resin film such as polyethylene terephthalate (PET) may be used. The coating method may utilize, for example, a die coating method, a micro gravure coating method, a wire bar coating method, a direct gravure coating method, a reverse roll coating method, a comma coating method, a knife coating method, a spray coating method, a curtain coating method, a dipping method, or a spin coating method, but is not particularly limited to the aforementioned methods.

### Preparation of Cathode Layer

Composite cathode active material particles may be prepared by coating a first solid electrolyte onto at least a portion of the surface of a cathode active material constituting the cathode active material layer 12. The composite cathode active material particles may be prepared by coating a first solid electrolyte powder onto a cathode active material, thus disposing the coating layer 15 onto the core 13 to form the composite cathode active material particle. As the coating method, dry coating, wet coating, or the like may be used.

The composite cathode active material particles, the second solid electrolyte 17, an organic binder, etc. may be mixed together, and the resulting mixture may be dispersed in an organic solvent. The organic solvent may be the same kind as the organic solvent used for the preparation of the solid electrolyte sheet or may be a different kind. The dispersed slurry may be printed on the solid electrolyte green sheet. The printing method may be, for example, a letterpress printing technique, an offset printing technique, a gravure printing technique, an intaglio printing technique, a rubber printing technique, a screen printing technique, etc. but is not particularly limited to the aforementioned techniques.

### Preparation of Anode Layer

An anode active material layer 22 may be prepared as follows. The anode active material may utilize, for example, carbon-based or metal-based particles, a mixture of carbon-based particles and metal-based particles, or the like. Anode active material particles, second solid electrolyte particles, an organic binder, etc. may be mixed together, and the resulting mixture may be dispersed in an organic solvent. The resulting product may be printed on a solid electrolyte green sheet in the same manner as the process of cathode layer preparation.

### Preparation of Current Collector Layer

A cathode current collector layer 11 or an anode current collector layer 21 may be prepared as follows. As a current collecting material, for example, materials such as carbon-based or metal-based particles, and a mixture of carbon-based particles and metal-based particles, may be used. Current collecting material particles, second solid electrolyte particles, an organic binder, etc. may be mixed together, and the resulting mixture may be dispersed in an organic solvent to prepare a current collecting material slurry. The current collecting material slurry may be printed on the anode layer or cathode layer prepared above, followed by drying. Thereafter, a cathode layer or an anode layer may be printed on the printed current collector layer.

The current collector layer may be omitted when unnecessary.

### Lamination and Firing Processes

The cathode layer/solid electrolyte green sheet and the anode layer/solid electrolyte green sheet prepared above may be laminated up to a few hundred times, followed by pressing the resulting lamination so as to apply a pressure in a thickness direction. The pressing method may utilize a cold press, a hot press, a cold isostatic press (CIP), a warm isostatic press (WIP), or the like.

Subsequently, the pressed lamination may be cut to a predetermined size and shape. Thereafter, a calcination process may be carried out in an oxygen atmosphere.

Firing (e.g., sintering) the calcined lamination may remove organic binders and sinter lithium ion conductors included in each green sheet constituting the lamination at the same time. An appropriate temperature of the lamination may be about 500° C. or less. The firing may utilize a box furnace, a hot press furnace, a spark plasma sintering furnace, and the like.

According to an embodiment, the heat-treatment may be carried out at a temperature of about 500° C. or less. Since the glass transition temperature of the first solid electrolyte and the second solid electrolyte is about 500° C. or less, the first solid electrolyte and the second solid electrolyte may be co-sintered with a lithium transition metal oxide included in the core at a temperature of about 500° C. or less. In this case, the cathode may be manufactured more rapidly. In addition, since the sintering temperature corresponds to about 500° C. or less, damage to the cathode active material due to exposure to a temperature of about 500° C. or greater, may be effectively prevented.

According to an embodiment, the sintering temperature may be about 450° C. to about 500° C., about 460° C. to about 500° C., about 470° C. to about 500° C., about 450° C. to about 490° C., about 460° C. to about 490° C., about 470° C. to about 490° C., or about 475° C. to about 490° C.

The present inventive concept will be described in greater detail through the following examples and comparative examples. However, it will be understood that the examples are provided only to illustrate the present inventive concept and not to be construed as limiting the scope of the present inventive concept.

### EXAMPLES

### Example 1: Cl-LBSO (Coating Layer)+LBSO (Second Solid Electrolyte)+LBSO (Third Solid Electrolyte) Sintered at 490° C., Half-Cell All-Solid Secondary Battery

### Preparation of First Solid Electrolyte: Preparation of Cl-LBSO

First solid electrolyte 15 serving as a coating layer was prepared as follows. First, a mixture was prepared by mixing Li₂O, SiO₂, B₂O₃, P₂O₅, GeO₂, Al₂O₃, and LiCl as raw materials in a molar ratio of 43:11:37:1:3:1:4. Subsequently, the mixture was melted to a melt and vitrified through rapid cooling. The rapid cooling was performed by pressing the solution with a metal plate. The cooled solid electrolyte was formed into a powder body by dry mechanical milling. The average particle diameter of the halogen-containing oxide-based solid electrolyte was 0.6 μm, and this was a volume-based median diameter (D50) as measured using a laser-type particle diameter distribution analyzer.

### Preparation of Second Solid Electrolyte: Preparation of LBSO

Second solid electrolyte 17 as a matrix in a cathode layer was prepared as follows. First, a mixture was prepared by mixing Li₂O, SiO₂, and B₂O₃ as raw materials in a molar ratio of 50:16.7:33.3. Subsequently, the mixture was melted to a melt and vitrified through rapid cooling. The rapid cooling was performed by pressing the solution with a metal plate. The cooled solid electrolyte was formed into a powder body by dry mechanical milling. The average particle diameter of the halogen-free oxide-based solid electrolyte was 4.5 μm, and this was a volume-based median diameter (D50) as measured using a laser-type particle diameter distribution analyzer.

### Preparation of Third Solid Electrolyte for Electrolyte Layer: Preparation of LBSO

Solid electrolyte layer 30 constituting an electrolyte layer was prepared in the same manner as the preparation process of the second solid electrolyte. First, a mixture was prepared by mixing Li₂O, SiO₂, and B₂O₃ as raw materials in a molar ratio of 50:16.7:33.3. Subsequently, the mixture was melted to a melt and vitrified through rapid cooling. The rapid cooling was performed by pressing the solution with a metal plate. The cooled third solid electrolyte was powderized by dry mechanical milling. The average particle diameter of the halogen-free oxide-based solid electrolyte was 4.5 μm, and this was a volume-based median diameter (D50) as measured using a laser-type particle diameter distribution analyzer.

### Preparation of Solid Electrolyte Sheet

A solid electrolyte sheet was prepared as follows. The solid electrolyte powder for an electrolyte layer prepared above was mixed with an organic binder, and the resulting mixture was dispersed in an organic solvent, thereby forming a slurry. The organic solvent used was butyl acetate. Thereafter, the dispersed slurry was uniformly coated or printed onto a polyethylene terephthalate (PET) substrate, thereby forming the solid electrolyte sheet. The coating was carried out through a roll coating method. Then, the solid electrolyte sheet was dried in an oven at 80° C. for 1 hour.

### Preparation of Cathode Layer

LiCoO₂ (LCO) was prepared as a cathode active material. The composite cathode active material prepared above and the LCO were coated through dry mixing to prepare a composite cathode active material. The ratio of the LCO and the first solid electrolyte used for the coating was 50:10 in volume. Composite cathode active material particles, a second solid electrolyte, and an organic binder, etc. were mixed, and the resulting mixture was dispersed in butyl acetate, thereby forming a paste. Here, the ratio of LCO:first solid electrolyte:second solid electrolyte was 50:10:40. Subsequently, the dispersed paste was printed on a stainless steel plate as a cathode current collector by using a screen-printing method. Thereafter, the cathode layer thus formed was dried under vacuum at 120° C. for 6 hours.

### Lamination and Firing Processes

Onto the prepared cathode layer, the solid electrolyte sheet was transferred at 130° ° C. under a pressure of 450 kg, and then a silver (Ag)-carbon (C) composite was transferred at 100° C. under a pressure of 450 kg. The resulting lamination was then subjected to a calcination process at 350° C. for 3 hours. Subsequently, the lamination was fired in air by pressure-assisted sintering. The pressure-assisted sintering was carried out by a heat-treatment at 490° C. for 30 minutes under 90 MPa.

### Battery Preparation and Evaluation

After attaching Li to the fired sample, the sample was assembled into a coin cell and a battery evaluation was performed.

### Example 2: Cl-LBSO (Coating Layer)+LBSO (Matrix)+LBSO (Third Solid Electrolyte) Sintered at 470° C., Half-Cell All-Solid Secondary Battery

An all-solid secondary battery was prepared following the same process as in Example 1, except that the pressure-assisted sintering temperature during the lamination and firing processes was adjusted to 470° C.

### Comparative Example 1: LBSO (Coating Layer)+LBSO (Matrix)+LBSO (Third Solid Electrolyte) Sintered at 490° C., Half-Cell All-Solid Secondary Battery

An all-solid secondary battery was prepared in the same manner as in Example 1 except that the coating layer for the preparation of the cathode active material layer included LBSO instead of Cl-LBSO.

### Comparative Example 2: LBSO (Matrix)+LBSO (Third Solid Electrolyte) Sintered at 490° C., Half-Cell All-Solid Secondary Battery

An all-solid secondary battery was prepared in the same manner as in Example 1 except that no coating layer was applied for the preparation of the cathode active material layer.

### Comparative Example 3: Cl-LBSO (Matrix)+LBSO (Third Solid Electrolyte) Sintered at 490° C., Half-Cell All-Solid Secondary Battery

An all-solid secondary battery was prepared in the same manner as in Example 1 except that for the preparation of the cathode active material layer, no coating layer was applied, and the matrix included LBSO instead of Cl-LBSO.

### Comparative Example 4: Cl-LBSO (Coating Layer)+Cl-LBSO (Matrix)+Cl-LBSO (Third Solid Electrolyte) Sintered at 490° C., Half-Cell All-Solid Secondary Battery

An all-solid secondary battery was prepared in the same manner as in Example 1 except that both the matrix and the solid electrolyte included Cl-LBSO.

### Comparative Example 5: Cl-LBSO (Coating Layer)+Cl-LBSO (Matrix)+Cl-LBSO (Third Solid Electrolyte) Sintered at 470° C., Half-Cell All-Solid Secondary Battery

An all-solid secondary battery was prepared in the same manner as in Example 1 except that both the matrix and the third solid electrolyte included Cl-LBSO, and the sintering temperature was 470° C.

### Comparative Example 6: SiO₂—P₂O₅—LiCl (Coating Layer)+LBSO (Matrix)+LBSO (Third Solid Electrolyte) Sintered at 490° C., Half-Cell All-Solid Secondary Battery

An all-solid secondary battery was prepared in the same manner as in Example 1 except that the coating layer included SiO₂—P₂O₅—LiCl instead of Cl-LBSO.

### Comparative Example 7: Li₂O—LiCl—B₂O₃(Coating Layer)+LBSO (Matrix)+LBSO (Third Solid Electrolyte) Sintered at 490° C., Half-Cell All-Solid Secondary Battery

An all-solid secondary battery was prepared in the same manner as in Example 1 except that the coating layer included Li₂O—LiCl—B₂O₃ instead of Cl-LBSO.

TABLE 1

| | | | | | | Sintering |
|---|---|---|---|---|---|---|
| | Coating layer | | Matrix | | | temperature |
| | Type | Tg (° C.) | Type | Tg (° C.) | Electrolyte | (° C.) |
| Example 1 | Cl—LBSO | 417 | LBSO | 412 | LBSO | 490 |
| Example 2 | Cl—LBSO | 417 | LBSO | 412 | LBSO | 470 |
| Comparative | LBSO | 412 | LBSO | 412 | LBSO | 490 |
| Example 1 | | | | | | |
| Comparative | — | — | LBSO | 412 | LBSO | 490 |
| Example 2 | | | | | | |
| Comparative | — | — | Cl—LBSO | 417 | LBSO | 490 |
| Example 3 | | | | | | |
| Comparative | Cl—LBSO | 417 | Cl—LBSO | 417 | Cl—LBSO | 490 |
| Example 4 | | | | | | |
| Comparative | Cl—LBSO | 417 | Cl—LBSO | 417 | Cl—LBSO | 470 |
| Example 5 | | | | | | |
| Comparative | SiO₂—P₂O₅—LiCl | 330 | LBSO | 412 | LBSO | 490 |
| Example 6 | | | | | | |
| Comparative | Li₂O—LiCl—B₂O₃ | 460 | LBSO | 412 | LBSO | 490 |
| Example 7 | | | | | | |

Tg: Glass transition temperature

### Evaluation Example 1: Measurement of Initial Capacity and Rate Capability

Using the half-cells assembled according to Examples 1 and 2 and Comparative Examples 1 to 7, initial capacity and rate capability were measured. Each battery was charged and discharged at 60° C. with an upper charging voltage of 4.35 V and a lower discharge voltage of 2.0 V. In particular, each battery was charged and discharged over 2 cycles at 0.05 C, 0.1 C, 0.2 C, 0.5 C, and 1.0 C with respect to the cathode active material, followed by charging and discharging at 0.1 C. 0.1 C or C/10 refers to a current that will fully discharge the battery in 10 hours.

The initial capacity refers to a specific discharge capacity in the first cycle at 0.05 C, and the rate capability is a value expressed as a percentage of each discharge amount at 0.2 C, 0.5 C, and 1.0 C vs. initial capacity.

The results of the measurement are shown in Table 2.

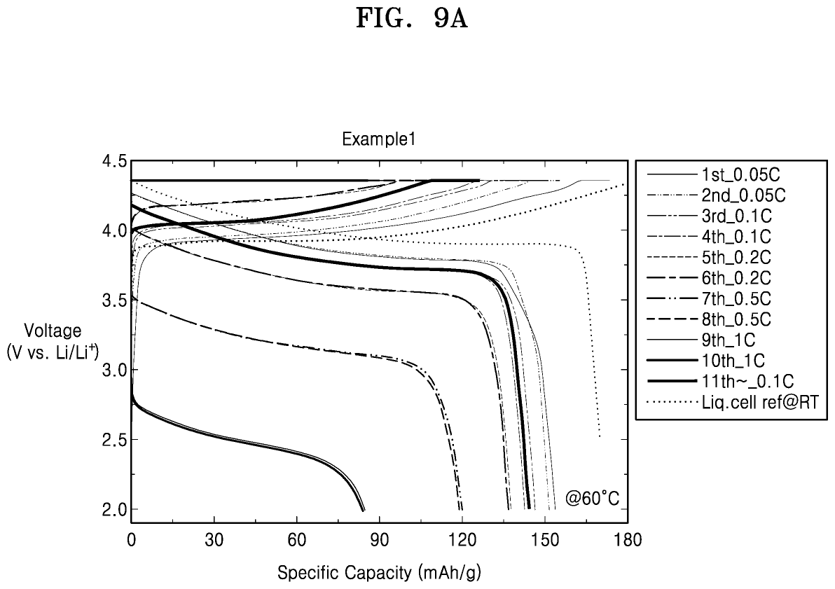

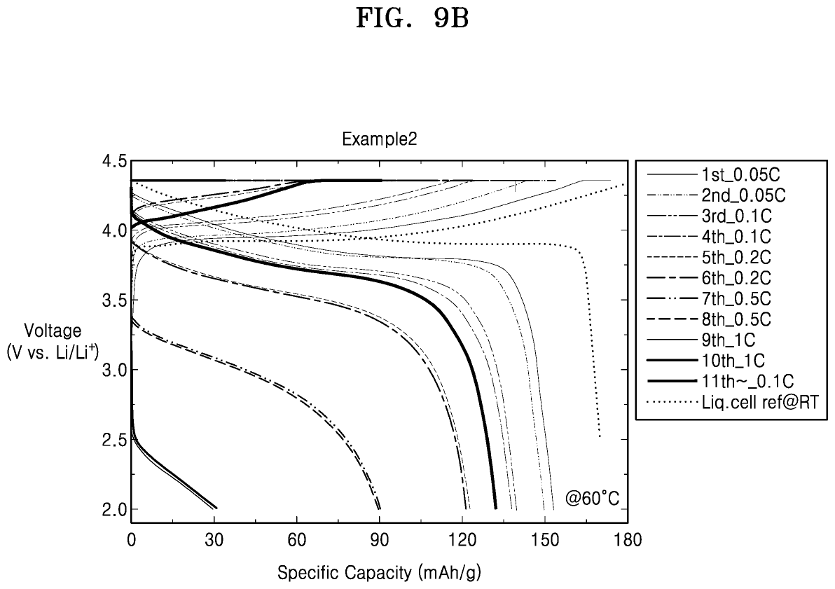

In addition, graphs showing the results of measurement of charge-discharge characteristics of the lithium batteries according to Examples 1 and 2 are shown in FIG. 9A and FIG. 9B.

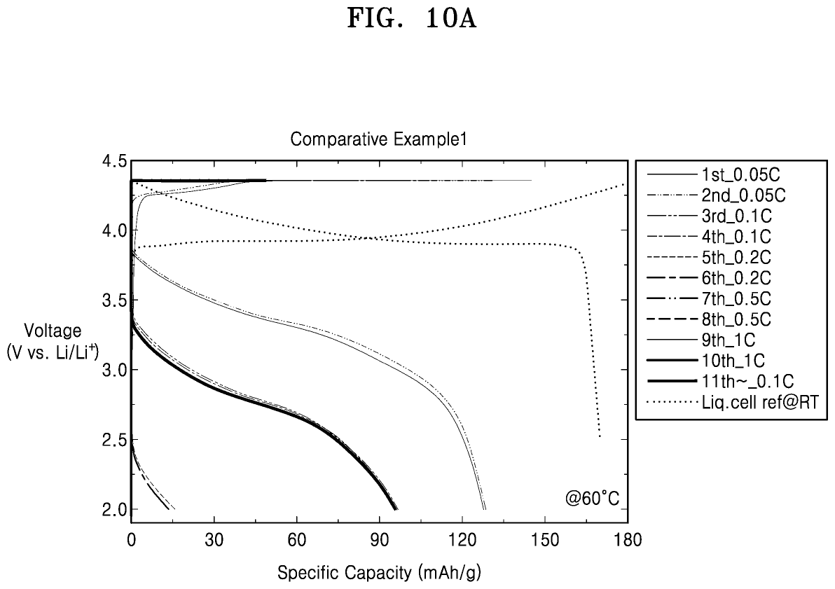

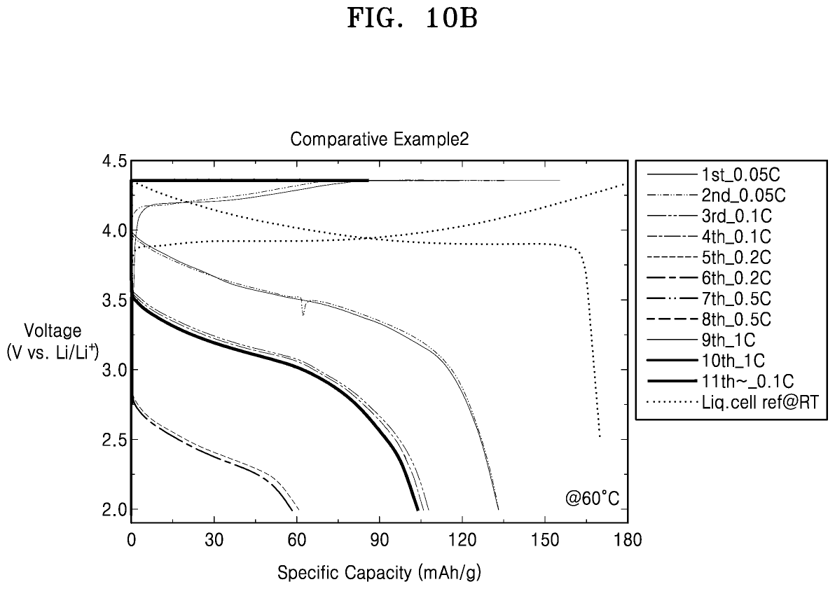

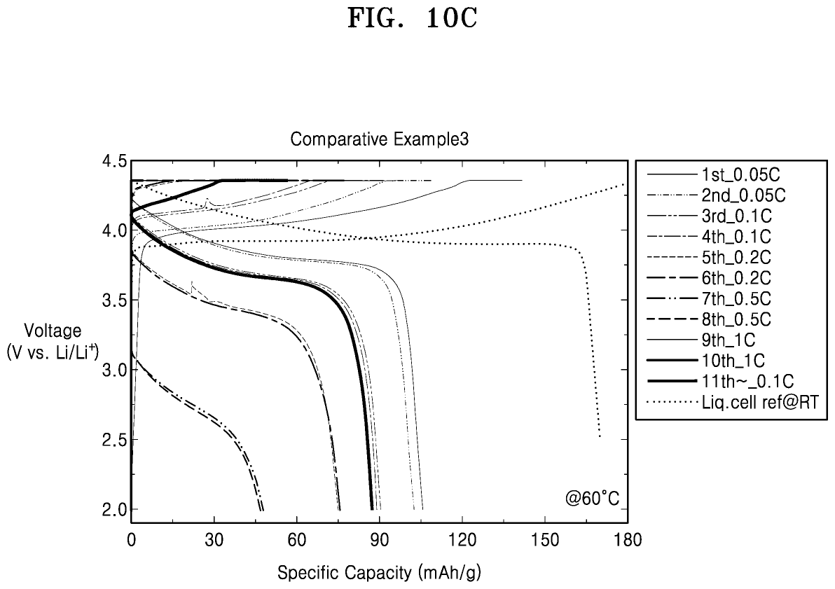

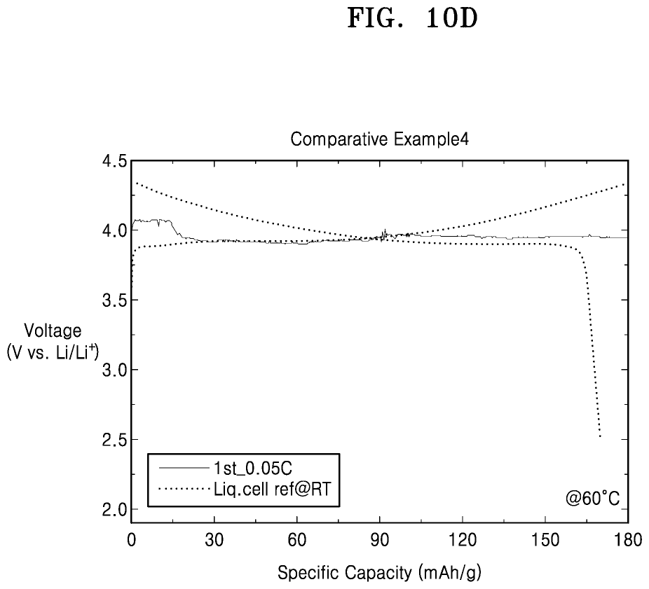

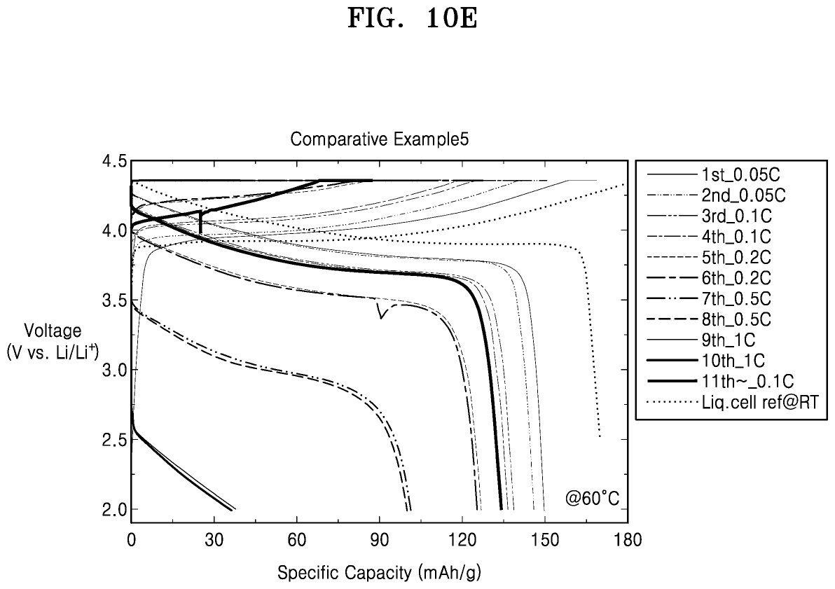

In addition, graphs showing the results of measurement of charge-discharge characteristics of the lithium batteries according to Comparative Examples 1 to 5 are shown in FIG. 10A and FIG. 10E.

TABLE 2

| | 0.05 C | Rate Capability (%) | | |
|---|---|---|---|---|
| | Capacity | (Capacity/0.05 C capacity) × 100% | | |
| | (mAh/g) | 0.2 C/0.05 C | 0.5 C/0.05 C | 1 C/0.05 C |
| Example 1 | 154 | 89 | 78 | 55 |
| Example 2 | 153 | 80 | 59 | 20 |
| Comparative | 134 | 45 | 0 | 0 |
| Example 1 | | | | |
| Comparative | 128 | 12 | 0 | 0 |
| Example 2 | | | | |
| Comparative | 106 | 72 | 45 | 0 |
| Example 3 | | | | |
| Comparative | Short | | | |
| Example 4 | | | | |
| Comparative | 150 | 85 | 68 | 25 |
| Example 5 | | | | |
| Comparative | N/A | N/A | N/A | N/A |
| Example 6 | | | | |
| Comparative | N/A | N/A | N/A | N/A |
| Example 7 | | | | |

As shown in Table 1, the all-solid secondary batteries of Examples 1 and 2 were found to facilitate the manufacturing of all-solid secondary batteries and provide excellent initial capacity and rate capability.

The secondary batteries of Comparative Examples 1 to 3 showed a decrease in initial capacity as the coating layer did not contain halogen atoms, and relatively poor rate capability due to a high internal resistance.

In the secondary battery of Comparative Example 4, as the inclusion of halogen atoms in the matrix and the electrolyte layer causes electron conductivity to increase, a short circuit occurred due to electrons passing through the electrolyte layer.

In the secondary battery of Comparative Example 5, while the matrix and the electrolyte layer contained halogen atoms, the sintering temperature was 470° C. which caused a slight decrease in electron conductivity, and as a result, no short circuit occurred; however, compared to when the sintering was conducted at 490° C., there was an overall decrease in electron conductivity, which caused a decrease in initial capacity and rate capability.

In the secondary batteries according to Comparative Examples 6 and 7, due to the absence of silicon (Si) and boron (B) in the first solid electrolyte, the coating layer was not sufficiently adhered to the surface of the cathode active material, thus causing the battery to fail to operate.

In particular, in Comparative Example 6, the low crystallization temperature caused the ion conductivity to decrease at the target sintering temperature, thus causing the battery to fail to operate.

As described above, the lithium secondary battery associated with the present examples may be applied to a variety of portable devices, vehicles, and the like.

Exemplary embodiments have been described in greater detail with reference to the accompanied drawings, but the present inventive concept is not limited to these examples. While one or more embodiments have been described with reference to the figures, it will be understood by those of ordinary skill in the art that various changes in form and details may be made therein without departing from the spirit and scope of the disclosure as defined by the following claims.

According to an aspect, provided is a secondary battery which has increased initial capacity and improved rate capability by including a cathode having a novel structure and composition.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode comprising:
a cathode active material layer comprising
a composite cathode active material particle comprising
a core, and
a coating layer disposed on at least a portion of the core, wherein the core comprises a lithium transition metal oxide, and the coating layer comprises a first solid electrolyte, wherein the first solid electrolyte is a halogen-containing oxide solid electrolyte; and
a matrix comprising a second solid electrolyte, wherein the second solid electrolyte is a halogen-free oxide solid electrolyte, and
wherein the composite cathode active material particle is disposed in the second solid electrolyte, and
wherein the first solid electrolyte and the second solid electrolyte each comprise silicon and boron.

2. The cathode of claim 1,
wherein the halogen-free oxide solid electrolyte has a halogen content of less than about 1 mole percent, based on a total content of the halogen-free oxide solid electrolyte.

3. The cathode of claim 1,
wherein the halogen comprises chlorine.

4. The cathode of claim 1,
wherein the first solid electrolyte further comprises lithium and oxygen.

5. The cathode of claim 4,
wherein the first solid electrolyte further comprises aluminum, phosphorus, germanium, or a combination thereof.

6. The cathode of claim 1,
wherein the second solid electrolyte further comprises lithium and oxygen.

7. The cathode of claim 1,
wherein the first solid electrolyte and the second electrolyte each have a glass transition temperature of about 500° C. or less.

8. The cathode of claim 1,
wherein a sum of a volume of the first solid electrolyte and a volume of the second solid electrolyte is about 15 volume percent or greater, with respect to a total volume of the cathode active material layer.

9. The cathode of claim 1,
wherein each of the first solid electrolyte and the second solid electrolyte has an ion conductivity of about 1×10⁻⁸ Siemens per centimeter or greater.

10. The cathode of claim 1,
wherein a ratio of an electron conductivity of the first solid electrolyte to an ion conductivity of the first solid electrolyte is about 100 or less.

11. The cathode of claim 1,
wherein an ion conductivity of the second solid electrolyte is greater than an ion conductivity of the first solid electrolyte.

12. The cathode of claim 1,
wherein an electron conductivity of the first solid electrolyte is greater than an electron conductivity of the second solid electrolyte.

13. The cathode of claim 1,
wherein the coating layer has a thickness of about 1 nanometer to about 3 micrometers.

14. The cathode of claim 1,
wherein the coating layer is disposed continuously on an entire surface of the cathode active material.

15. The cathode of claim 1,
wherein the cathode has a thickness of about 1 micrometer to about 100 micrometers.

16. The cathode of claim 1,
wherein the cathode has a Young's modulus of about 10 gigapascals to about 100 gigapascals.

17. A lithium battery comprising:
the cathode of claim 1;
an anode; and
an electrolyte between the cathode and the anode.

18. The lithium battery of claim 17,
wherein the electrolyte comprises a third solid electrolyte, and
the third solid electrolyte comprises a halogen-free oxide solid electrolyte.

19. A method of preparing a cathode, the method comprising:
providing a composite cathode active material particle comprising
a core, and
a coating layer disposed on at least a portion of the core,
wherein the core comprises a lithium transition metal oxide, and the coating layer comprises a first solid electrolyte, wherein the first solid electrolyte is a halogen-containing oxide solid electrolyte;
impregnating the composite cathode active material particle into a matrix comprising a second solid electrolyte, wherein the second solid electrolyte is a halogen-free oxide solid electrolyte to form an impregnated matrix; and
heat-treating the impregnated matrix to form a cathode active material layer to form the cathode,
wherein the first solid electrolyte and the second solid electrolyte each comprise silicon and boron.

20. The method of claim 19,
wherein the heat-treating comprises heat-treating at a temperature of about 500° C. or less.
